(19) United States
(12) Patent Application Publication
(10) Pub. No.: US 2025/0224626 A1
(43) Pub. Date: Jul. 10, 2025

(54) LOCALIZED MIRROR DIMMING CONTROL

(71) Applicant: GM Global Technology Operations LLC, Detroit, MI (US)

(72) Inventors: Mark A. Stebbins, Bloomfield Township, MI (US); Craig Thomas Douglas, Pflugerville, TX (US)

(21) Appl. No.: 18/406,570

(22) Filed: Jan. 8, 2024

(51) Int. Cl. G02F 1/01; B60R 1/08

(52) U.S. Cl. CPC G02F 1/0121; B60R 1/08; G02F 2203/09

(57) ABSTRACT

A mirror assembly for a vehicle includes a mirror element configured to reflect light from a light source and generate an image, a light sensor assembly configured to detect an intensity of light incident on a plurality of regions corresponding to a reflective area of the mirror assembly, and a control device configured to locally reduce an intensity of reflections in a subset of the plurality of regions based on the detected incident light intensity.

### INTRODUCTION

The subject disclosure relates to presentation of visual information to a user of a vehicle. More particularly, the subject disclosure pertains to control of vehicle mirrors.

Many vehicles include mirrors that have features designed to reduce glare. Such mirrors may have relatively simple mechanisms (e.g., tabs) that allow a driver or passenger to manually tilt the mirror, or more complex features such as electrically dimmable mirrors. Existing mirrors can be susceptible to washout, in which portions of a mirror image have reduced visibility or contrast due to a bright light source.

### SUMMARY

In one exemplary embodiment, a mirror assembly for a vehicle includes a mirror element configured to reflect light from a light source and generate an image, a light sensor assembly configured to detect an intensity of light incident on a plurality of regions corresponding to a reflective area of the mirror assembly, and a control device configured to locally reduce an intensity of reflections in a subset of the plurality of regions based on the detected incident light intensity.

In addition to one or more of the features described herein, the light sensor assembly includes a support structure having a surface parallel to the mirror element, and a plurality of light sensors arrayed along the surface, each light sensor corresponding to a respective region of the reflective area.

In addition to one or more of the features described herein, the control device includes a transparent layer having a plurality of sections, each section corresponding to a respective region of the reflective area, wherein a transparency of each section is independently controllable.

In addition to one or more of the features described herein, the control device is configured to reduce the transparency of a section by applying an electric current to the section.

In addition to one or more of the features described herein, the mirror element is partially transparent and configured to allow an amount of the light to pass through the mirror element to the light sensor assembly.

In addition to one or more of the features described herein, the mirror element forms a first layer of the mirror assembly, the light sensor assembly forms a back-plane layer and the transparent layer of the control device forms a fore-plane layer, and the mirror element is a mirror layer disposed between the back-plane layer and the fore-plane layer.

In addition to one or more of the features described herein, the mirror assembly includes a processing device configured to determine the incident light intensity detected by each light sensor, and compare the incident light intensity to a threshold intensity.

In addition to one or more of the features described herein, the processing device is configured to reduce the transparency of a section of the transparent layer based on the incident light intensity detected for a region being greater than the threshold intensity.

In addition to one or more of the features described herein, the threshold intensity includes at least one of a selected intensity value, and a difference between a detected incident light intensity at a first region and a detected incident light intensity at a second region.

In another exemplary embodiment, a method includes monitoring a user of a vehicle, where the monitoring includes determining at least one of whether the user is looking at a mirror assembly in the vehicle, and whether a face of the user is illuminated by reflections from an external light source. The mirror assembly includes a mirror element configured to reflect light and generate an image, a light sensor assembly configured to detect an intensity of light incident on a plurality of regions corresponding to a reflective area of the mirror assembly, and a control device. The method also includes, based on determining that the user is looking at the mirror assembly or that the face is illuminated, comparing a detected incident light intensity at each region of the plurality of regions to a threshold intensity, identifying a subset of the plurality of regions for which a detected incident light intensity exceeds the threshold intensity, and reducing an intensity of reflections at the subset of the plurality of regions.

In addition to one or more of the features described herein, the light sensor assembly includes a support structure having a surface parallel to the mirror element, and a plurality of light sensors arrayed along the surface, each light sensor corresponding to a respective region of the reflective area.

In addition to one or more of the features described herein, the control device includes a transparent layer having a plurality of sections, each section corresponding to a respective region of the reflective area, wherein a transparency of each section is independently controllable.

In addition to one or more of the features described herein, the control device is configured to reduce the transparency of a section by applying an electric current to the section.

In addition to one or more of the features described herein, reducing the intensity of the reflections at the subset reduces a wash out of the image in one or more other regions of the plurality of regions.

In addition to one or more of the features described herein, the threshold intensity includes at least one of: a selected intensity value, and a difference between a detected incident light intensity at a first region and a detected incident light intensity of a second region.

In yet another exemplary embodiment, a vehicle system includes a memory having computer readable instructions, and a processing device for executing the computer readable instructions, the computer readable instructions controlling the processing device to perform a method. The method includes monitoring a user of a vehicle, where the monitoring includes determining at least one of whether the user is looking at a mirror assembly in the vehicle, and whether a face of the user is illuminated by reflections from an external light source. The mirror assembly includes a mirror element configured to reflect light and generate an image, a light sensor assembly configured to detect an intensity of light incident on a plurality of regions corresponding to a reflective area of the mirror assembly, and a control device. The method also includes, based on determining that the user is looking at the mirror assembly or that the face is illuminated, comparing a detected incident light intensity at each region to a threshold intensity, identifying a subset of the plurality of regions for which the detected incident light intensity exceeds the threshold intensity, and reducing an intensity of reflections at the subset of the plurality of regions.

In addition to one or more of the features described herein, the light sensor assembly includes a support structure having a surface parallel to the mirror element, and a plurality of light sensors arrayed along the surface, each light sensor corresponding to a respective region of the reflective area.

In addition to one or more of the features described herein, the control device includes a transparent layer having a plurality of sections, each section corresponding to a respective region of the reflective area, wherein a transparency of each section is independently controllable.

In addition to one or more of the features described herein, the control device is configured to reduce the transparency of a section by applying an electric current to the section.

In addition to one or more of the features described herein, the threshold intensity includes at least one of: a selected intensity value, and a difference between a detected incident light intensity at a first region and a detected incident light intensity of a second region.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including a monitoring system and a mirror control system, in accordance with an exemplary embodiment;

FIG. 2 is a cross-sectional view of a mirror assembly having localized transparency control, in accordance with an exemplary embodiment;

FIG. 3 is a flow diagram depicting aspects of a method of controlling a transparency of a mirror assembly, in accordance with an exemplary embodiment;

FIG. 4 depicts various layers of the mirror assembly of FIG. 2, in accordance with an exemplary embodiment;

FIGS. 5A and 5B depict an example of an image reflected by a conventional mirror, and an example of an image reflected by the mirror assembly of FIG. 4; and

FIG. 6 depicts a computer system in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, methods, devices and systems are provided for control of dimming or transparency of a mirror assembly. An embodiment of a mirror assembly includes a mirror element configured to reflect light from an external light source (e.g., ambient light, streetlights, vehicle headlights, etc.), and generate an image. The mirror element (or a separate control device) is controllable by a processing device to adjust an intensity of the image based on detecting a light level incident on each of a plurality of regions of the mirror assembly's reflective surface area. Each region is independently controllable, allowing for localized dimming.

“Localized dimming” refers to dimming of a selected region or regions making up a portion of the mirror assembly's overall reflective area. The dimming may be achieved by detecting light intensity at each of an array of light sensors, where each light sensor corresponds to a respective region. The detected intensity is compared to a threshold intensity. For each detected intensity that exceeds the threshold, a corresponding region is dimmed by locally reducing the transparency, thereby reducing the intensity of a reflected image in the region as compared to a remainder of the reflected image. The transparency of the remainder of the reflective area is left unchanged.

In an embodiment, the processing device is configured to use a driver monitoring system to determine whether an occupant is using a given mirror assembly, and/or to determine a viewing angle. The processing device is configured to initiate a dimming or transparency control method based on determining that a user is looking at the mirror assembly and/or is illuminated by reflections from the mirror assembly.

Embodiments described herein present numerous advantages and technical effects. The embodiments provide for more effective and flexible dimming, including active localized dimming of reflections from light sources. Such active dimming as described herein provides for reducing or minimizing washout in a perceived image. Conventional mirrors, such as auto dimming mirrors, do not have local dimming capability, in that such mirrors are only able to dim an entire reflective area. The embodiments provide for mirror image washout prevention, which enables mirror utilization of images that would not otherwise be clearly seen due to uniform dimming.

The embodiments are not limited to use with any specific vehicle and may be applicable to various contexts. For example, embodiments may be used with automobiles, trucks, aircraft, construction equipment, farm equipment, automated factory equipment and/or any other device or system for which additional thermal control may be desired to facilitate a device or system's existing thermal control capabilities or features.

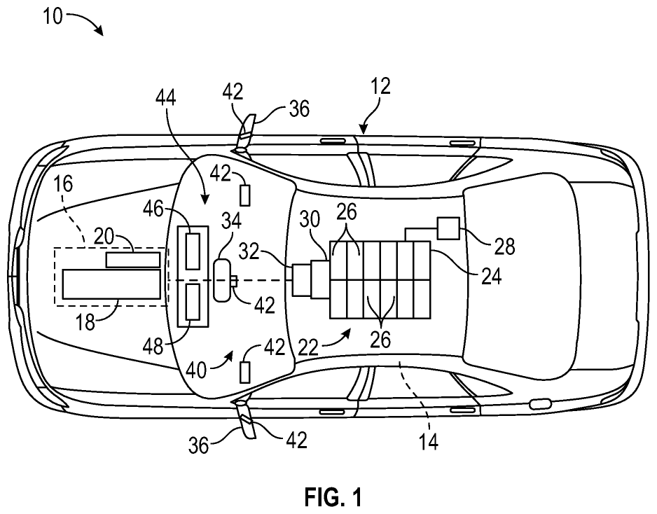

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle may be a combustion engine vehicle, an electrically powered vehicle (EV), fuel cell or a hybrid electric vehicle (HEV). In an example, the vehicle 10 is a hybrid vehicle that includes a combustion engine 18 and an electric motor 20.

The vehicle 10 includes a battery system 22, which may be electrically connected to the motor 20 and/or other components, such as vehicle electronics. In an embodiment, the battery system 22 includes a battery assembly such as a high voltage battery pack 24 having a plurality of battery modules 26. The battery system 22 may also include a monitoring unit 28 configured to receive measurements from various sensors.

The battery system 22 includes various conversion devices for controlling the supply of power from the battery pack 24 to the motor 20 and/or electronic components. The conversion devices include, for example a direct current (DC)-DC converter module 30 and an inverter module 32.

The vehicle 10 also includes various mirror assemblies (mirrors) to facilitate driver awareness. For example, the vehicle 10 includes a rearview mirror 34 and side mirrors 36. One or more of the mirror assemblies is configured to provide for localizing dimming as discussed herein.

In an embodiment, the vehicle 10 includes a monitoring system 40, which includes one or more sensors used to monitor a vehicle occupant, such as a driver and/or passenger. For example, the monitoring system 40 includes one or more optical cameras 42 configured to take images, which may be still images and/or video images. Other sensors may include photocells for determining, for example, eye and/or facial illumination. Additional devices may be included in the system 40, such as image analysis components. Such devices may be incorporated into a driver monitoring system (DMS).

One or more of the mirror assemblies (also referred to hereinafter as mirrors) is configured to locally reduce (“dim”) the intensity or brightness of reflections of one or more regions of a reflective area of the mirror, so that the brightness of a region of an image is reduced relative to other portions of the image. As discussed further herein, by employing localized dimming of a selected region, the washing out of other regions is reduced or avoided. “Washout” or “washing out” refers to a phenomenon in which regions around a particularly bright or intense part of an image have a reduced perceived contrast.

The vehicle 10, the rearview mirror 34, the side mirror(s) 36 and/or the cameras 42 (and/or any other devices used for occupant monitoring) are connected to an on-board computer system 44 that includes one or more processing devices 46 and a user interface 48. The user interface 48 may include a touchscreen, a speech recognition system and/or various buttons for allowing a user to interact with features of the vehicle. The various processing devices and units may communicate with one another via a communication device or system, such as a controller area network (CAN) or transmission control protocol (TCP) bus.

One or more processing devices in the vehicle 10 is/are configured to perform aspects of a method of controlling the intensity or brightness of portions of an image. As discussed further herein, the method includes detecting light levels (e.g., intensity, brightness, etc.) incident on a plurality of regions or locations of a mirror assembly, and locally dimming one or more regions based on the detected light levels. The method may also include monitoring an occupant to determine whether a mirror assembly is being utilized, and/or determining a viewing angle relative to a mirror surface.

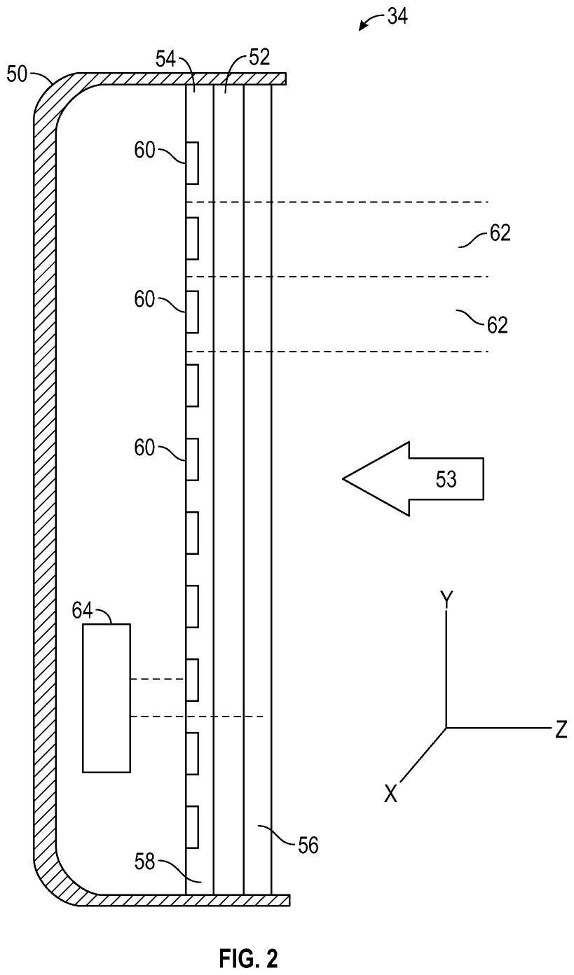

FIG. 2 is a cross-section of an embodiment of the rearview mirror 34, which is configured to have automatic and localized dimming control as described herein. It is noted that components provided for automatic dimming control may be incorporated into other types of mirror assemblies and devices (e.g., convex mirrors).

As described herein, “dimming” refers to control of an intensity or amount of light that is reflected from a given region or location of a mirror element. As a result, the brightness of a region or location in the image is reduced as compared to the remainder of the image. In this way, glare from light sources is reduced while avoiding washout.

The rearview mirror 34 includes a housing 50 that supports multiple mirror components, referred to herein as “layers.” The layers include a mirror layer 52 having a constant transparency level, such as silvered or chrome-plated glass. The thickness of the plating is selected to allow a desired amount of light to transmit through the mirror layer 52.

The mirror layer 52, in an embodiment, is disposed between a back-plane layer 54 and a fore-plane layer 56. The back-plane layer is disposed behind the mirror layer 52 relative to incident light 53, and the fore-plane layer 56 is disposed in front of the mirror layer 52.

The back-plane layer 54 is configured to detect the light level or intensity of light that passes through different regions of the mirror layer 52 (i.e., the incident light intensity). In an embodiment, the back-plane layer 54 includes a flat support structure 58 (e.g., glass, polymer, etc.) having an array of light sensors 60. Each light sensor 60 corresponds to a respective region 62 of the rearview mirror 34, referred to herein as a “pixel.” Any suitable light sensors may be used, such as a photodiodes, photoresistors, phototransistors and others.

The fore-plane layer 56 is or includes a control device that allows for local dimming or local control of reflected light intensity. In an embodiment, the fore-plane layer 56 is made from a glass material or other transparent material having a controllable transparency. An example of such a material (sometimes referred to as “smart glass”) is a glass material (e.g., electrochromic, liquid crystal, suspended particle device (SPD), etc.) having a transparency that is controllable by applying an electric current thereto.

In an embodiment, the fore-pane layer 56 includes a material having constant transparency (e.g., conventional glass, polymer, etc.) and a film or layer of smart glass material attached thereto.

To establish local control of transparency, the fore-plane layer 56 may be an integral body with multiple conductors or leads terminating at different locations. In another example, the fore-plane layer 56 is made from an array of individual sections of the material that are attached together and are each independently connected to a source of electric current.

The rearview mirror also includes or is connected to a controller 64, which is configured to control one or more aspects of operation of the rearview mirror 34. For example, the controller 64 is connected to the light sensors 60 and configured to receive signals from the light sensors 60 and estimate an incident light intensity at each region. In addition, the controller 64 may also be configured to control the transparency of the fore-plane layer 56 or individual sections of the fore-plane layer 56 based on detected incident light intensity.

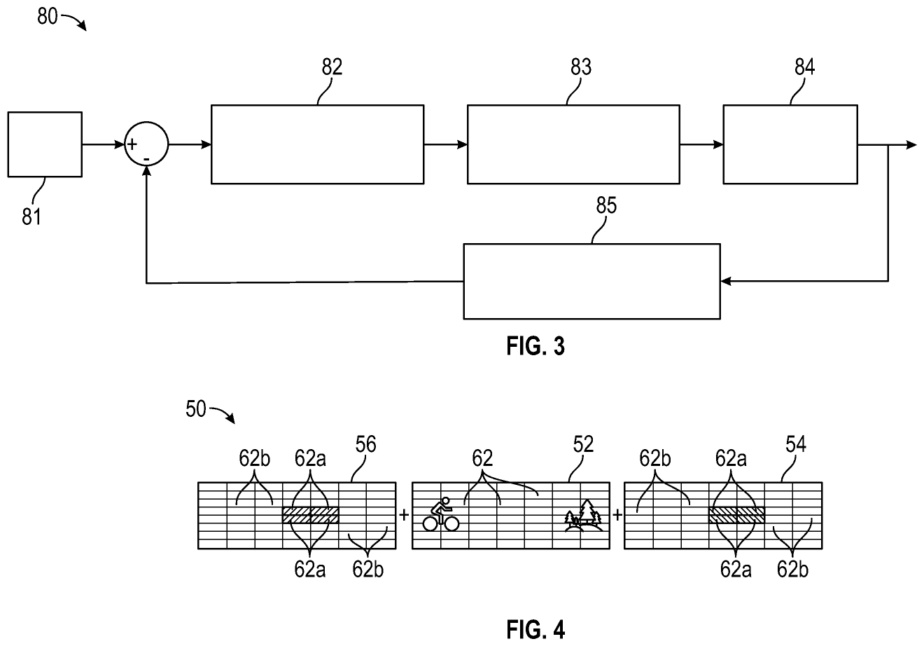

FIG. 3 illustrates embodiments of a method 80 of controlling a mirror assembly of a vehicle. Aspects of the method 80 may be performed by the controller 64, the computer system 44, and/or other suitable processing device.

The method 80 is described in conjunction with the vehicle 10 and components thereof, but is not so limited, as the method 80 may be performed in conjunction with any suitable vehicle, and with any suitable device or system that includes a mirror or mirrors used by an operator or other user.

The method 80 includes a number of steps or stages represented by blocks 81-85. The method 80 is not limited to the number or order of steps therein, as some steps represented by blocks 81-85 may be performed in a different order than that described below, or fewer than all of the steps may be performed.

At block 81, during operation of the vehicle 10, or upon a driver or occupant entering the vehicle 10, the processing device initiates light detection via the light sensors 60 in the back-plane layer 54. In an embodiment, the method 80 is initiated based on detecting that a driver or user is looking toward the rearview mirror 34. For example, the cameras 42 are used to detect the position of the driver's head and/or the direction of the driver's gaze. In addition, one or more photodetectors (or image analysis) may be used to detect an amount of illumination of the driver's face from mirror reflections.

At block 82, detection signals from the light sensors 60 are received by the processing device, and the processing device determines a light level or intensity of incident light associated with each sensor 60 (and the corresponding region of the reflective area of the rearview mirror 34).

Each detected light level is compared to a selected threshold. The threshold may be an absolute light level, or a relative light level. For example, the threshold light level may be a difference between a detected light level of a given sensor and a detected light level of one or more adjacent sensors. In another example, the threshold light level is a difference between the light level of a given sensor and a reference sensor (e.g., a sensor detecting a lowest light level). In other examples, the threshold is a rate of change of the light level detected by a sensor.

At block 83, based on one or more sensors 60 detecting a light level that exceeds the threshold, an automatic dimming process is performed to reduce the reflected light intensity of at least one portion or pixel 62 of the mirror area. As a result, the reflected image directed to a user is locally dimmed, allowing for clear view of the remainder of the image (block 84).

The dimming process may include dimming the sections of the fore-plane layer 56 at actual pixels 62 corresponding to the light sensor(s) 60 that detect an intensity exceeding the threshold. In an embodiment, the viewing angle of the user relative to the reflective area of the mirror is estimated. A pixel or pixels 62 that are dimmed are selected based on the viewing angle, so that the regions that are dimmed coincide with the image as seen by the user.

In an embodiment, the method 80 includes closed-loop control based on monitoring a user or occupant of the vehicle 10. For example, at block 85, a camera 42 mounted proximate to each mirror 34, 36 is monitored to determine whether a driver or passenger is looking toward a mirror 34, 36. In addition, or alternatively, the camera 42 and/or a photodetector is used to determine an amount of illumination of the user's face. The monitoring is provided as feedback to determine when to initiate light detection and dimming control.

FIG. 4 depict aspects of an example of performance of the method 80. As shown, each layer defines a respective region or pixel 62. A light sensor 60 (not shown) is provided in the back-plane layer 54 for each pixel 62.

In this example, a subset of the light sensors corresponding a group of pixels 62 (denoted as pixels 62a) detects light having an intensity above a selected threshold. In response, the controller 64 applies an electric current to sections of the fore-plane layer 56 at each pixel 62a to reduce the transparency. As a result, the region made up by pixels 62a is darkened, and the remaining pixels 62b have an unchanged reflected light intensity.

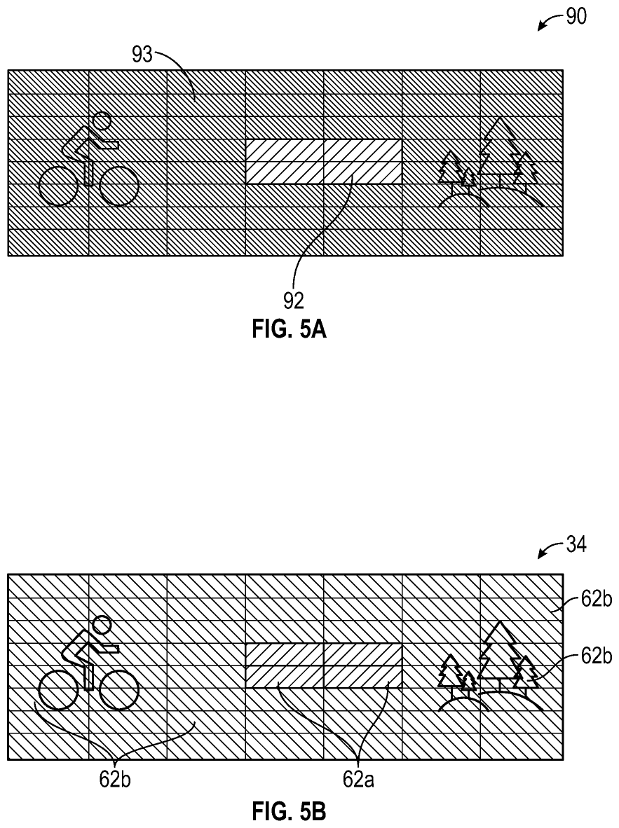

As noted herein, embodiments provide for local dimming of a portion of an image reflected by a mirror, to reduce glare and increase visibility, without washing out or otherwise impeding the clarity and contrast of other portions of the image. FIGS. 5A and 5B show an example of a mirror image generated according to embodiments described herein, in comparison to an image generated by a conventional dimmable mirror.

FIG. 5A shows a reflective surface of a conventional dimmable mirror 90, in which the entire reflective area of the mirror is dimmed to reduce the intensity of a high intensity light source (e.g., a trailing vehicle headlights). A region 92 reflects light from the high intensity light source. Uniform dimming resulted in dimming of the light source in the region 92. However, this dimming causes significant washout (contrast reduction) in the remaining area 93 of the mirror 90. As a result, other features in the image (e.g., a bicyclist and trees) become more difficult to discern.

FIG. 5B shows the reflective surface of the rearview mirror 34. As can be seen, although the region corresponding to the pixels 62a are dimmed, the surrounding pixels 62b do not have significantly reduced contrast. As such, a driver or occupant can clearly see the entirety of the image.

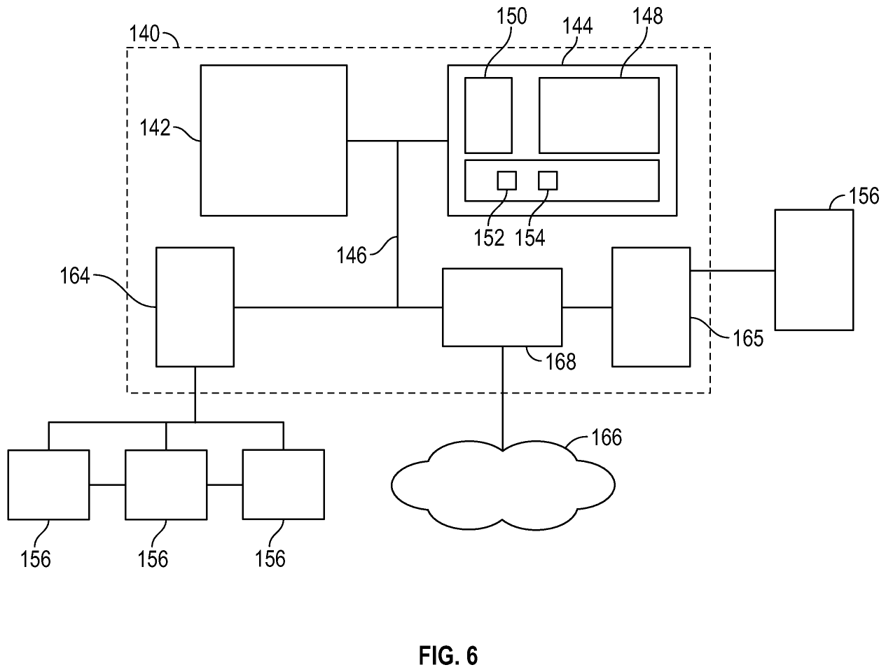

FIG. 6 illustrates aspects of an embodiment of a computer system 140 that can perform various aspects of embodiments described herein. The computer system 140 includes at least one processing device 142, which generally includes one or more processors for performing aspects of image acquisition and analysis methods described herein.

Components of the computer system 140 include the processing device 142 (such as one or more processors or processing units), a memory 144, and a bus 146 that couples various system components including the system memory 144 to the processing device 142. The system memory 144 can be a non-transitory computer-readable medium, and may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module 152 may be included for performing functions related to monitoring a user, and a module 154 may be included to perform functions related to light detection and dimming control as described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A mirror assembly for a vehicle, comprising:
a mirror element configured to reflect light from a light source and generate an image;
a light sensor assembly configured to detect an intensity of light incident on a plurality of regions corresponding to a reflective area of the mirror assembly; and
a control device configured to locally reduce an intensity of reflections in a subset of the plurality of regions based on the detected incident light intensity.

2. The mirror assembly of claim 1, wherein the light sensor assembly includes a support structure having a surface parallel to the mirror element, and a plurality of light sensors arrayed along the surface, each light sensor corresponding to a respective region of the reflective area.

3. The mirror assembly of claim 2, wherein the control device includes a transparent layer having a plurality of sections, each section corresponding to a respective region of the reflective area, wherein a transparency of each section is independently controllable.

4. The mirror assembly of claim 3, wherein the control device is configured to reduce the transparency of a section by applying an electric current to the section.

5. The mirror assembly of claim 3, wherein the mirror element is partially transparent and configured to allow an amount of the light to pass through the mirror element to the light sensor assembly.

6. The mirror assembly of claim 5, wherein the mirror element forms a first layer of the mirror assembly, the light sensor assembly forms a back-plane layer and the transparent layer of the control device forms a fore-plane layer, and the mirror element is a mirror layer disposed between the back-plane layer and the fore-plane layer.

7. The mirror assembly of claim 3, further comprising a processing device configured to determine the incident light intensity detected by each light sensor, and compare the incident light intensity to a threshold intensity.

8. The mirror assembly of claim 7, wherein the processing device is configured to reduce the transparency of a section of the transparent layer based on the incident light intensity detected for a region being greater than the threshold intensity.

9. The mirror assembly of claim 7, wherein the threshold intensity includes at least one of a selected intensity value, and a difference between a detected incident light intensity at a first region and a detected incident light intensity at a second region.

10. A method comprising:
monitoring a user of a vehicle, wherein the monitoring includes determining at least one of: whether the user is looking at a mirror assembly in the vehicle, and whether a face of the user is illuminated by reflections from an external light source, the mirror assembly including a mirror element configured to reflect light and generate an image, a light sensor assembly configured to detect an intensity of light incident on a plurality of regions corresponding to a reflective area of the mirror assembly, and a control device; and
based on determining that the user is looking at the mirror assembly or that the face is illuminated, comparing a detected incident light intensity at each region of the plurality of regions to a threshold intensity, identifying a subset of the plurality of regions for which a detected incident light intensity exceeds the threshold intensity, and reducing an intensity of reflections at the subset of the plurality of regions.

11. The method of claim 10, wherein the light sensor assembly includes a support structure having a surface parallel to the mirror element, and a plurality of light sensors arrayed along the surface, each light sensor corresponding to a respective region of the reflective area.

12. The method of claim 11, wherein the control device includes a transparent layer having a plurality of sections, each section corresponding to a respective region of the reflective area, wherein a transparency of each section is independently controllable.

13. The method of claim 12, wherein the control device is configured to reduce the transparency of a section by applying an electric current to the section.

14. The method of claim 10, wherein reducing the intensity of the reflections at the subset reduces a wash out of the image in one or more other regions of the plurality of regions.

15. The method of claim 10, wherein the threshold intensity includes at least one of: a selected intensity value, and a difference between a detected incident light intensity at a first region and a detected incident light intensity of a second region.

16. A vehicle system comprising:
a memory having computer readable instructions; and
a processing device for executing the computer readable instructions, the computer readable instructions controlling the processing device to perform a method including:
monitoring a user of a vehicle, wherein the monitoring includes determining at least one of: whether the user is looking at a mirror assembly in the vehicle, and whether a face of the user is illuminated by reflections from an external light source, the mirror assembly including a mirror element configured to reflect light and generate an image, a light sensor assembly configured to detect an intensity of light incident on a plurality of regions corresponding to a reflective area of the mirror assembly, and a control device; and
based on determining that the user is looking at the mirror assembly or that the face is illuminated, comparing a detected incident light intensity at each region to a threshold intensity, identifying a subset of the plurality of regions for which the detected incident light intensity exceeds the threshold intensity, and reducing an intensity of reflections at the subset of the plurality of regions.

17. The vehicle system of claim 16, wherein the light sensor assembly includes a support structure having a surface parallel to the mirror element, and a plurality of light sensors arrayed along the surface, each light sensor corresponding to a respective region of the reflective area.

18. The vehicle system of claim 17, wherein the control device includes a transparent layer having a plurality of sections, each section corresponding to a respective region of the reflective area, wherein a transparency of each section is independently controllable.

19. The vehicle system of claim 18, wherein the control device is configured to reduce the transparency of a section by applying an electric current to the section.

20. The vehicle system of claim 16, wherein the threshold intensity includes at least one of: a selected intensity value, and a difference between a detected incident light intensity at a first region and a detected incident light intensity of a second region.
